(19) United States
(12) Patent Application Publication
(10) Pub. No.: US 2026/0131334 A1
(43) Pub. Date: May 14, 2026

(54) CUTTING SCREEN WITH EVENLY DISTRIBUTED CUTTING SURFACES

(71) Applicant: VOGELSANG GMBH & CO. KG, Essen (DE)

(72) Inventors: Peter Hartogh, Essen (DE); Hugo Vogelsang, Essen (DE)

(73) Assignee: VOGELSANG GMBH & CO. KG, Essen (DE)

(21) Appl. No.: 19/386,731

(22) Filed: Nov. 12, 2025

(30) Foreign Application Priority Data
Nov. 13, 2024 (DE) 102024133229.8

(51) Int. Cl. B02C 23/16; B02C 18/10

(52) U.S. Cl. CPC B02C 23/16; B02C 18/10; B02C 2023/165

(57) ABSTRACT

A cutting screen for use in wet grinders with an inner peripheral region, an outer peripheral region, and a cutting screen having a working region of blank sections and material sections. The working region is scraped over by at least one cutting edge in operation. A circumferential ratio (UV) is the ratio of accumulated lengths of material sections along a circumferential line, and at least one continuous, circumferential function F exists for the cutting screen, which maps a circumferences U onto a reference circumferential ratio RUV, wherein the circumferential ratio (UV) for each circumference U of a circle concentric to the working region of the cutting screen and lying within the working region does not deviate from the reference circumferential ratio RUV=F(U) more than 0.05 of the reference circumferential ratio (RUV) at the respective circumference.

### CROSS-REFERENCE TO FOREIGN PRIORITY APPLICATION

The present application claims the benefit under 35 U.S.C. §§ 119(b), 119(e), 120, and/or 365(c) of German Application No. DE 10 2024 133 229.8 filed Nov. 13, 2024.

### FIELD OF THE INVENTION

The present invention relates to a cutting screen for use in wet grinders. Furthermore, the invention relates to a wet grinder for grinding solids, wherein the wet grinder comprises a cutting screen.

### BACKGROUND OF THE INVENTION

Liquid or sludge-like media, which are partly loaded with solids, in particular fibrous and/or fiber-containing solids, are processed, inter alia, in the food industry, pulp industry, in the slaughterhouse industry, or in the operation of biogas plants or sewage treatment plants. During the transport and/or the processing of such solids-containing media, a wide variety of plant elements are used: pipelines, feed pumps, throttles, etc. In order as far as possible not to damage or block such elements, the solids-containing media should not contain large solids or long fibers. Otherwise, for example, downstream pumps can be blocked and/or pipes can be damaged. The result is complex maintenance work and/or plant shutdown. Wet grinders, also called maceraters, and heavy material separators are therefore frequently used at the beginning of the material flow through the plant. Heavy material separators separate heavy solids (e.g., stones). Light solids, such as wood residues, bones, hair, fibers or food residues, are shredded in the wet grinder. Various principles of wet grinders are known, e.g., twin-shaft grinders. In the scope of the present application, a cutting screen of a wet grinder is proposed, in which the grinding is effected by a circular cutting screen arranged in the wet grinder, which is scraped over by at least one cutting blade rotating relative to the cutting screen. The cutting screen has openings of certain sizes. Solids are comminuted between the cutting screen and the at least one cutting blade by shearing forces until they are small enough to pass through the openings of the circular cutting screen.

The applicant distributes generic grinding devices under the brand name RotaCut. The construction of such a grinding device is described in WO 2012/032175 A1. An adjustment mechanism adjusts a second cutting element (cutting blade) movable relative to a first cutting element (cutting screen) relative to the first cutting element in such a way that, in the event of wear of cutting edges of the cutting elements, permanent contact of the second cutting element with the first cutting element takes place. This is ensured in particular by the use of a hydraulic cylinder. The first cutting element is preferably a cutting screen with a multiplicity of openings, the boundary edges of which form cutting edges.

The design of a cutting screen geometry is subject to various challenges. Depending on the selected field of use, the ball passage size has to be suitably selected, so that ground solids and fibers are sufficiently small for further processing. At the same time, the ball passage size selected must not be too small to ensure a certain volume throughput. Under certain circumstances, materials which are resistant to chemicals processed in operation are to be used. In order to maximize change intervals, the geometry should be as low-wear as possible in operation. The applicant offers cutting screens with various geometries, from which the most suitable for the respective application can be selected. In order to further increase the efficiency, in order to maximize maintenance intervals and pursuing a sustainable, long-lasting product design, there is a need to further optimize the material properties and the geometric properties of cutting screens for wet grinders. In particular, it has not been sufficiently taken into account to date that the shearing effect of the cutting screen to the cutting edge of a cutting blade and different contact conditions of the cutting edge on the cutting screen result in locally different wear of the cutting blade along the cutting edge of the cutting blade. The cutting edge of the cutting blade wears non-uniformly. Consequently, the shearing effect which the cutting blade in combination with the cutting screen exerts on solids is also locally different in the worn state. The shearing performance consequently decreases and the volume throughput is lower.

It is therefore the object of the invention to provide a cutting screen with improved wear properties which, during operation, leads to improved, more uniform wear of the cutting edges of cutting blades. Furthermore, it is the object of the invention to provide a system for grinding solids in mixed fluids which, using the cutting screen, permits the lengthening of maintenance intervals for changing the cutting screens and/or cutting blades.

### SUMMARY OF THE INVENTION

The object is achieved by a cutting screen with the features disclosed herein. Such a cutting screen comprises an inner peripheral region and an outer peripheral region, wherein the cutting screen comprises a working region of blank sections and material sections between the inner and the outer peripheral region, wherein the working region is provided to be scraped over by a cutting edge in operation. A circumferential line of a circle within a working region crosses material sections and blank sections. A circumferential ratio UV is the ratio of accumulated lengths of material sections along a circumferential line to a circumference U associated with the circumferential line. At least one continuous, curvature-change-free circumferential function F exists for the cutting screen, which maps circumferences U onto a reference circumferential ratio RUV. A cutting screen according to the invention is characterized in that the circumferential ratio UV for each circumference U of a circle concentric to the working region of the cutting screen and lying within the working region does not deviate from the reference circumferential ratio RUV=F(U) more than 0.05, preferably 0.03, preferably 0.01 of the reference circumferential ratio at the respective circumference.

The invention is based on the finding that the wear of a cutting edge rotating relative to the cutting screen depends decisively on the contacts of the rotating cutting edge with the cutting screen. The cutting screen comprises a working region. The working region is that region which is scraped over by at least one cutting edge in operation. It can also be referred to as an active surface. In operation, the rotating cutting edge abuts the cutting screen, more precisely the material sections of the working region of the cutting screen. The cutting edge of the cutting blade is pressed against the cutting screen by an adjustment mechanism with a setting force. The setting force acts on those sections of the cutting edge of the cutting blade which are in contact with material sections of the cutting screen. On the other hand, there are other load states at those sections of the cutting edge of the cutting blade which are located on blank sections of the cutting screen: here, solids to be shredded in operation are cut through. In this case, transverse forces act on the cutting screen, the strength of which is dependent on the type of solids (material, geometry, etc.).

The shape of the working region of the cutting screen is round. A position of the cutting edge scrapes over material sections and blank sections in operation. In the case of a rotation of the cutting edge, the circumferential ratio UV denotes the ratio of material sections along a circumferential line of the cutting screen to the circumference U associated with the circumferential line. For a cutting edge, the rotational movement of which is concentric to the working region of the cutting screen, a radius R or—by multiplying the radius R by 2×π—a circumference U can be assigned to each position along the cutting edge. The circumferential ratio UV takes values between 0 and 1 for each circumference U. The greater the value of the circumferential ratio, the more frequently contact with the cutting screen occurs during one revolution of the cutting edge of the cutting blade.

Cutting edges of cutting blades and cutting screens are particularly susceptible to wear if the circumferential ratio assumes different values for different positions (radii, circumferences) along a cutting edge. In particular, increased wear occurs if strongly varying circumferential ratios occur at adjacent positions along the cutting edge, that is to say, discontinuities of the circumferential ratio occur along the radius. According to the invention, it is therefore provided to avoid such discontinuities of the circumferential ratio along a cutting edge as far as possible. This means that at least one continuous and curvature-change-free circumferential function F exists, which maps circumferences U onto a reference circumferential ratio RUV (i.e., no sudden, wear-promoting discontinuities of the circumferential ratio occur) and the geometry of a cutting screen according to the invention is characterized in that the circumferential ratio UV for each circumference U of a circle concentric to the working region of the cutting screen and lying within the working region does not deviate from the reference circumferential ratio RUV=F(U) more than 0.05, preferably 0.03, preferably 0.01 of the reference circumferential ratio at the respective circumference. Accordingly, the circumferential ratio UV deviates from the reference circumferential ratio RUV=F(U) at most by an amount which is located within a tolerance band. For metrological and manufacturing reasons, such a tolerance band is provided. For example, the reference circumferential ratio can be constant 0.5, i.e., independently of the circumference (or of the radius) approximately the same number of material sections as blank sections are provided on each circle concentric to the working region. Of course, for manufacturing and/or metrological reasons, an actually measured circumferential ratio of exactly 0.5 cannot be realized for each circumference. For example, for manufacturing and/or metrological reasons, there is noise, that is to say small deviations from the reference circumferential ratio. In the example mentioned and for deviations of up to 0.05, circumferential ratios of up to 0.55 can be determined at some circumferences, and circumferential ratios of 0.45 can be determined at other circumferences. It should be understood that other reference circumferential ratios are also possible, and that in particular the reference circumferential ratio does not have to be a constant function—as in the example mentioned. It can equally well be another circumferential function F, provided that it is continuous and curvature-change-free.

The determination of the circumferential ratio UV of a cutting screen can be carried out, for example, on the basis of a photographic transmitted-light recording of the cutting screen and a subsequent, computer-aided evaluation of the recording. In the computer-aided evaluation, transmitted-light regions are blank regions and shadow regions are material regions of the cutting screen. With computer-aided means known per se, the circular shape of the cutting screen is recognized on the basis of a transmitted-light recording. However, the blank regions can also be set at an angle with respect to a rotation axis of the cutting screen. For the determination of the blank regions and material regions, in such a case, instead of a transmitted-light recording, the recording of a front surface of the cutting screen is to be used and an evaluation can be carried out with a photographic reflected-light recording of the cutting screen.

The working region, within which the circumferential ratios do not deviate from a reference circumferential ratio more than 0.05, preferably 0.03, preferably 0.01, is provided to be scraped over by at least one cutting edge in operation. In this case, scraping over denotes a rotational relative movement of the cutting edge relative to the cutting screen. In this case, the cutting edge can be at least partially in contact with the cutting screen or a narrow gap can be provided between the cutting edge and the cutting screen, in which gap shearing forces for grinding the solids occur in operation.

The working region is limited by a boundary on the inside of a circle and a boundary on the outside of a circle. The boundary on the inside of a circle and the boundary on the outside of a circle run at those inner or outer radii, respectively, at which the cutting screen is just no longer scraped over by a cutting blade in operation. Preferably, the boundary on the inside of a circle or the boundary on the outside of a circle runs along the smallest or largest radius, respectively, at which at least one change from a material section to a blank section takes place in the circumferential direction. Peripheral regions outside the working region can be filled continuously with material, for example, or can be provided with bores for centering pins or for fixing elements, for example screws. Consequently, other ratios of material sections to blank sections can also be provided in peripheral regions and a peripheral region circumferential ratio does not have to satisfy the conditions of a continuous, curvature-change-free function within a tolerance band.

With consideration of this definition of the working region, the circumferential ratios for a cutting screen can be determined in a computer-aided manner at different positions (radii, circumferences) of the working region and can be plotted with respect to the circumference. For computer-aided evaluation of the geometric ratios of a cutting screen, a photographic recording, for example a scan, is preferably selected. Preferably, two different pixel states can be read from the recording, wherein material sections are recognized in one pixel state (e.g., dark) and blank sections are recognized in the other pixel state (e.g., bright). For example, a pixel can be recorded at least in every hundredth of the radius of the boundary on the outside of a circle of the working region. The resolution is preferably to be selected to be higher.

Preferably, at least one continuous, curvature-change-free angle function G also exists for the cutting screen, which maps circle angles φ onto a reference radial ratio RRV, wherein a radial ratio (RV) is the ratio of all accumulated lengths of material sections along a radial cutting line L to the length of the cutting line L, wherein the cutting line L encloses an angle φ∈[0°, 360°] with a radial horizontal cutting line, wherein the cutting line extends over the working region without protruding into the inner edge region and/or into the outer peripheral region, and wherein the radial ratio (RV) for each radial cutting line with a circle angle φ∈[0°, 360°] does not deviate from the reference radial ratio RRV=G(φ) more than 0.15, preferably 0.1. Advantageously, no sudden, strong changes in the radial ratio in the running direction occur for such cutting screens during the rotation of the cutting edge relative to the cutting screen. Consequently, better concentricity is ensured in operation. Vibrations are minimized. Fewer impulse-like, sudden loads occur on the cutting edge of the cutting blade. This has an advantageous effect on the wear resistance and lengthens maintenance intervals.

It is furthermore preferred that the function (F) is convex, linear, or constant. The function (F) is then not concave. The terms “convex” and “concave” in this case relate to a representation in which the circumferential ratio is plotted increasingly in the positive direction on the ordinate and the radius is plotted in the positive direction on the abscissa. A constant function F advantageously has uniform circumferential ratios for each radial position of the cutting blade within the working range. In the respective application, however, it can also be advantageous if the function F is linear or convex. In particular, the wear of cutting edges on cutting blades on the inner or outer edge of the cutting screen can be greater if the setting of the cutting blade on the cutting screen takes place by compressive forces, for example, on the inner or on the outer edge. The wear behavior on the outer edge can also be greater depending on the use case than on the inner edge if, for example, larger solids are more likely to be shredded on the outer edge as a result of the centrifugal force than on the inner edge, and greater shearing loads occur there. Advantageously, such differences in the wear behavior along a cutting edge can be compensated by a corresponding configuration of a cutting screen, the circumferential ratio of which does not deviate from the reference circumferential ratio RUV more than 0.05, preferably 0.03, preferably 0.01, wherein the reference circumferential ratio follows a convex or linear function.

Furthermore, a cutting screen is preferred in which the working area comprises an area of at least 30%, preferably 40%, 50%, 60%, 70%, 80% of a front surface of the cutting screen and of at most 95%, preferably 90%, 85%, 80%, 70% of the front surface of the cutting screen. In this case, the front surface is the circular surface which is enclosed by the circular shape of the circular cutting screen and consists substantially of inner and outer peripheral regions, and the working region arranged radially therebetween. The front surface comprises regions with material, and regions without material, for example blank sections, bores for fixing the cutting screen, and/or a passage for a drive shaft for driving a cutting blade. By defining a lower limit region of at least 30%, preferably 40%, 50%, 60%, 70%, 80% of the area, it is advantageously ensured that the volume throughput through the cutting screen is sufficiently high. By defining an upper limit region of at most 95%, preferably 90%, 85%, 80%, 70% of the front surface, it is ensured that sufficient possibilities for clamping and fixing the cutting screen can be attached to the outer peripheral region and that a passage for a drive shaft can be provided at the inner peripheral region.

In a further preferred embodiment or a further aspect of the invention, the inner peripheral region of the cutting screen comprises a central recess for receiving a rotation element, wherein the material sections are formed by a first plurality of first material struts, which extend spirally from the inside to the outside; and a second plurality of second material struts, which extend curved, preferably spirally, inverse to the first material struts from the inside to the outside, wherein material-free blank sections are enclosed by the first material struts, the second material struts, the inner peripheral region and the outer peripheral region. Here, the term “spirally” refers to a curve which runs around a point and, depending on the viewer's perspective, moves away from or approaches this point. In particular, the term here is not limited to the shape of Archimedean spirals and also comprises, for example, circular vaults. The material struts of this embodiment form material sections. First and second material struts, respectively, which are inverse to one another, advantageously support one another. In the further aspect of the invention mentioned here, a cutting screen for use in wet grinders with an inner peripheral region and an outer peripheral region is disclosed and claimed in particular, wherein the cutting screen comprises a working region of blank sections and material sections between the inner and the outer peripheral region, wherein the working region is provided to be scraped over by at least one cutting edge in operation, wherein the inner peripheral region comprising a central recess for receiving a rotation element, wherein the material sections are formed by a first plurality of first material struts, which extend spirally from the inside to the outside; and a second plurality of second material struts, which extend curved, preferably spirally, inverse to the first material struts from the inside to the outside, wherein material-free blank sections are enclosed by the first material struts, the second material struts, the inner peripheral region and the outer peripheral region. The preferred embodiments illustrated below relate explicitly both to the first aspect and to the further aspect of the invention.

The first material struts preferably extend involutely, in particular circularly involutely. Because of the constant winding distance of circular vaults, such an embodiment is particularly uniform.

It is furthermore preferred that the second material struts cross the first material struts. The intermediate spaces of the first and second material struts then form blank sections. Depending on the number, pitch, size of the material struts, and further design parameters, a ball passage size suitable for the respective application can be defined.

In a preferred embodiment, the second material struts have a substantially constant strut width from radially inside to radially outside, i.e., they preferably do not taper radially outwards or radially inwards. The circumferential ratio UV then decreases radially outwards, since a constant number of second material struts with a constant strut width faces an increasing circumference radially outwards. Radially outwards, the friction of the cutting edge of the cutting blade with respect to the cutting screen is then lower. Depending on the medium to be cut, this can be advantageous. For example, heavier solids can accumulate radially outwards due to the centrifugal force, which solids cause higher wear during shearing. It is then advantageous to keep the friction-related wear by the contact of the cutting screen with the cutting edge of the cutting blade radially outwards less than in the center of the cutting screen as compensation for this.

However, it is also preferred that the second material struts taper radially outwards. Ball passages are then larger with increasing radius.

It is equally preferred that the second material struts taper radially inwards. In this case, for example, an approximately constant circumferential ratio can be achieved for all circumferences within the working region. This is advantageous for achieving uniform comminution. Furthermore, radially outer regions are consequently designed to be thicker than radially inner regions. This is advantageous because, due to the centrifugal force, heavy solids, which can potentially cause more wear than light particles, accumulate more likely radially outwards. The radially outer regions are advantageously designed to be thicker and consequently more stable than radially inner regions.

It is preferred that the second material struts run from the inner peripheral region to the outer peripheral region. Within the working region, they then cross first material struts. Consequently, there are advantageously no T-joints. This is advantageous from a structural mechanical point of view.

Cutting angles are enclosed by each straight line, which extends radially to the outside from the center point of the cutting screen, with the second material struts crossing the straight line. In operation, one or more straight cutting blades which extend radially to the outside from the center point are usually used. The cutting screen is preferably configured to include cutting angles in a range of 10° to 30°, preferably in a range of 15° to 25°, preferably of 20°, when interacting with the cutting edge. At cutting angles in a range of 10° to 30°, preferably in a range of 15° to 25°, preferably at a cutting angle of 20°, a particularly reliable comminution of the solids to be ground takes place.

However, it can also be provided and is equally preferred that cutting blades are not arranged on a straight line which extends radially to the outside from the center point of the cutting screen. Cutting edges of the cutting blades are preferably arranged skewed with respect to a center axis which is perpendicular to a plane of the cutting screen and runs through the center point of the cutting screen. The distance of a cutting edge from the center axis is particularly preferably less than 3 cm, 2 cm, 1 cm, 0.5 cm. Cutting screens are particularly preferred which include cutting angles in a range of 10° to 30°, preferably in a range of 15° to 25°, preferably of 20°, with such cutting blades arranged skewed.

Each cutting angle is particularly preferably in a range of 10° to 30°, preferably in a range of 15° to 25°, preferably 20°. In the case of curvatures of the second material strut, the latter can include different cutting angles along the radius with the straight line or with the cutting blade. If all cutting angles are in a similar range, in particular in a range of 10° to 30°, preferably in a range of 15° to 25°, preferably are approximately 20°, then the cutting effect is advantageously less dependent on the radial position of the solid to be shredded.

Preferably and depending on the application, ball passage diameters of the blank sections are in a range from a lower limit, which is 5 mm, 10 mm, 15 mm, 20 mm, or 25 mm, to an upper limit, which is 25 mm, 30 mm, 35 mm, 40 mm, or 50 mm. For typical applications, this range is advantageously suitable, on the one hand, for further processing only sufficiently ground solids in the downstream plant elements and, on the other hand, for ensuring an efficient volume throughput. Within this range, an optimum of the ball passage size can be achieved for the respective application. It should be understood that a plurality of different ball passage diameters can also be present within a cutting screen, which ball passage diameters are, for example, smaller radially inwards than radially outwards.

The first material struts and the second material struts preferably have a hard surface and a tough core. The terms hard and tough are meant comparatively in the context of the present disclosure. This means that the core, i.e., the material interior of the first and second material struts, is configured to be tougher in comparison to the surface of the material struts.

The cutting screen preferably comprises one or more elements for positioning and/or securely fixing the cutting screen in a wet grinder.

The object is achieved in a further aspect by a system for grinding solids in mixed fluids, comprising a cutting screen according to the first aspect of the invention and at least one cutting blade. The working region of the cutting screen is preferably scraped over by the at least one cutting blade during rotation of the at least one cutting blade and is at least partially in contact with the at least one cutting blade. The cutting blade is configured to rotate about a rotation axis in operation. This rotation axis can be arranged offset with respect to a central axis. A rotation axis of the at least one cutting blade is particularly preferably coaxial to a central axis of the working region. Furthermore, a central axis of the cutting screen is preferably coaxial to the rotation axis of the at least one cutting blade.

A system is preferred in which the number of first material struts of the cutting screen is not dividable by the number of cutting blades. Typically, one, two, three, four, or six cutting blades, which are preferably uniformly distributed, are used in a wet grinder. The use of a number of first material struts, which is not dividable by the number of cutting blades, is advantageous for avoiding natural vibrations of the wet grinder during operation.

It is also preferred that the number of second material struts is not dividable by the number of cutting blades. This is likewise advantageous for avoiding natural vibrations of the wet grinder during operation.

In contrast to the prior art, preferred embodiments of the cutting screen according to the invention are explained on the basis of the attached figures. It should be understood that the cutting screen according to the first aspect of the invention and the system according to the second aspect of the invention have identical and similar sub-aspects, as are laid down in particular in the dependent claims. In this respect, for developments of the second aspect of the invention, reference is made fully to the developments of the first aspect of the invention.

### BRIEF DESCRIPTION OF THE DRAWINGS

In the figures:

FIG. 1 shows a perspective view of a preferred embodiment of a cutting screen according to the invention in a system for grinding solids with a representation of a cutting blade of a wet grinder;

FIG. 2a shows a front view of a first cutting screen from the prior art;

FIG. 2b shows a developed view of the first cutting screen from the prior art with an evaluation of the circumferential ratio;

FIG. 2c shows a developed view of the first cutting screen from the prior art with an evaluation of the radial ratio;

FIG. 3a shows a front view of a second cutting screen from the prior art;

FIG. 3b shows a developed view of the second cutting screen from the prior art with an evaluation of the circumferential ratio;

FIG. 3c shows a developed view of the second cutting screen from the prior art with an evaluation of the radial ratio;

FIG. 4a shows a front view of a third cutting screen from the prior art;

FIG. 4b shows a developed view of the third cutting screen from the prior art with an evaluation of the circumferential ratio;

FIG. 4c shows a developed view of the third cutting screen from the prior art with an evaluation of the radial ratio;

FIG. 5a shows a front view of a first exemplary embodiment of a cutting screen according to the invention;

FIG. 5b shows a developed view of the first exemplary embodiment of a cutting screen according to the invention with an evaluation of the circumferential ratio;

FIG. 5c shows a developed view of the first exemplary embodiment of a cutting screen according to the invention with an evaluation of the radial ratio;

FIG. 6a shows a front view of a second exemplary embodiment of a cutting screen according to the invention;

FIG. 6b shows a developed view of the second exemplary embodiment of a cutting screen according to the invention with an evaluation of the circumferential ratio;

FIG. 6c shows a developed view of the second exemplary embodiment of a cutting screen according to the invention with an evaluation of the radial ratio;

FIG. 7a shows a front view of a third exemplary embodiment of a cutting screen according to the invention;

FIG. 7b shows a developed view of the third exemplary embodiment of a cutting screen according to the invention with an evaluation of the circumferential ratio;

FIG. 7c shows a developed view of the third exemplary embodiment of a cutting screen according to the invention with an evaluation of the radial ratio;

FIG. 8a shows a cutting screen according to the invention in a system with four cutting blades and hidden rotor;

FIG. 8b shows a cutting screen according to the invention in a system with four cutting blades and hidden rotor; and

FIG. 9 shows a wet grinder with built-in cutting screen.

### DETAILED DESCRIPTION OF THE EMBODIMENTS

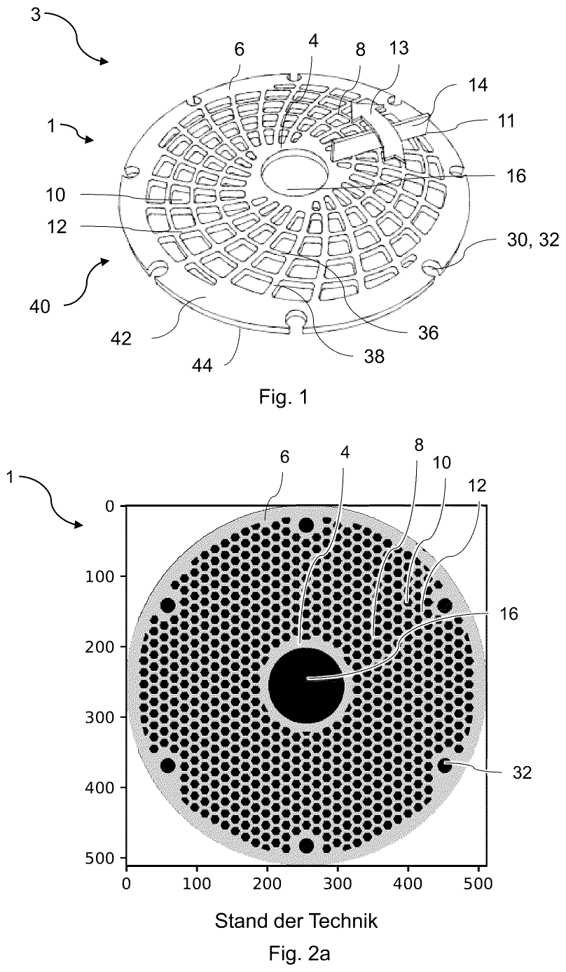

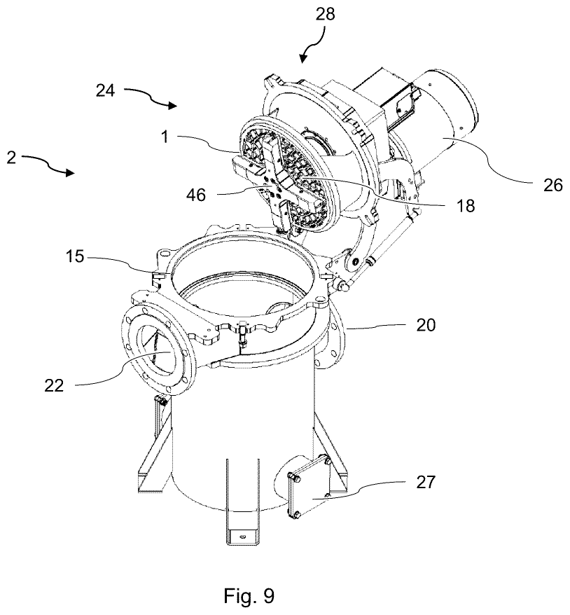

FIG. 1 shows a first embodiment of a cutting screen 1 for use in wet grinders 2 (cf. FIG. 9) with an inner peripheral region 4, an outer peripheral region 6, wherein the cutting screen 1 comprises a working region 8 of blank sections 10 and material sections 12 between the inner peripheral region 4 and the outer peripheral region 6, wherein the working region 8 is provided to be scraped over by a cutting edge 11 in operation. The cutting edge 11 is a separate component of the wet grinder 2 or part of a system 3 of cutting screen 1 and at least one cutting blade 14 and is shown here for illustration. The cutting edge 11 moves relative to the cutting screen 1 in a circular movement direction 13, wherein the circular shape of the movement direction 13 is concentric to that of the cutting screen 1. It should be understood that more than one cutting edge, for example two, three, four, five, or six cutting edges, can also be provided in operation, as shown in particular in FIG. 9. The cutting performance and the throughput of a medium to be processed are thus increased. The cutting edge 10 is the edge of a cutting blade 14 facing the cutting screen 1. The cutting blade 14 is arranged in a machine housing 15 shown in FIG. 9 in operation. In particular, a drive shaft 18 for rotationally driving the cutting blade 14 is arranged through an inner recess 16 in the inner peripheral region 4 of the cutting screen 1.

The wet grinder 2 in FIG. 9 also comprises a fluid inlet 20, a fluid outlet 22, an opening unit 24, a drive 26, a rotor 46, a heavy material separator 27, and a hydraulic adjustment unit 28. The hydraulic adjustment unit 28 is located between the cutting screen 1 and the drive 26 and is not shown here in detail. In operation, the fluid inlet 20 is connected to a feed and the fluid outlet 22 is connected to a discharge. These can be formed, for example, as pipes or hoses. Furthermore, the opening unit 24 is in a closed state in operation. In FIG. 9, the wet grinder 2 is not in operation, and the opening unit 24 is shown in an open state for better visibility of the cutting screen 1. In operation, solids with high density entering the wet grinder 2 sink due to gravity and collect in the heavy material separator 27.

Liquid, fibers, and solids with low density entering the wet grinder 2 are pressed upwards through the cutting screen 1. Large solids cannot easily pass through the blank sections 10 of the cutting screen 1 due to their geometric dimensions. Freely floating fibers are cut to a statistical, average length by rotating the cutting blades 14. By rotating the cutting blades 14 relative to the cutting screen 1, shearing forces arise between the cutting blades 14 and the cutting screen 1, which shear forces shredder the solids or fibers until they can pass through the blank sections 10.

Solids that could also pass through the cutting screen 1 without being shredded are shredded to a statistical geometric mean by randomly occurring cutting processes. This degree of shredding or the statistical geometric mean is dependent, inter alia, on the number of cutting blades 14, the rotational speed of the cutting blades 14, the flow speed and the geometric configuration of the cutting screen 1.

The fluid loaded with solids or fibers is then present at the fluid outlet 22 in a state in which the geometric dimensions of solids are more uniform and smaller than at the fluid inlet 20. The solids-loaded fluid can thus be further processed better in downstream plant components and downstream plant components are protected. Solids with high density can be, for example, stones or metals. Solids with low density can be, for example, textiles, hair, biological waste, leaves, grasses, bones, or the like.

The cutting blades 14 wear in particular at their cutting edges 11. The cutting screen 1 also wears in the edge region. The hydraulic adjustment unit 28 is configured to press the cutting edges 11 with an axial force in the direction of or against the cutting screen 1 even in a used state with partial wear. At contacts of the cutting edges 11 with the cutting screen 1 or at narrow gaps between the cutting edges 11 and the cutting screen 1, shearing forces on the solids-loaded fluid occur as a result of a torque provided by the drive 26.

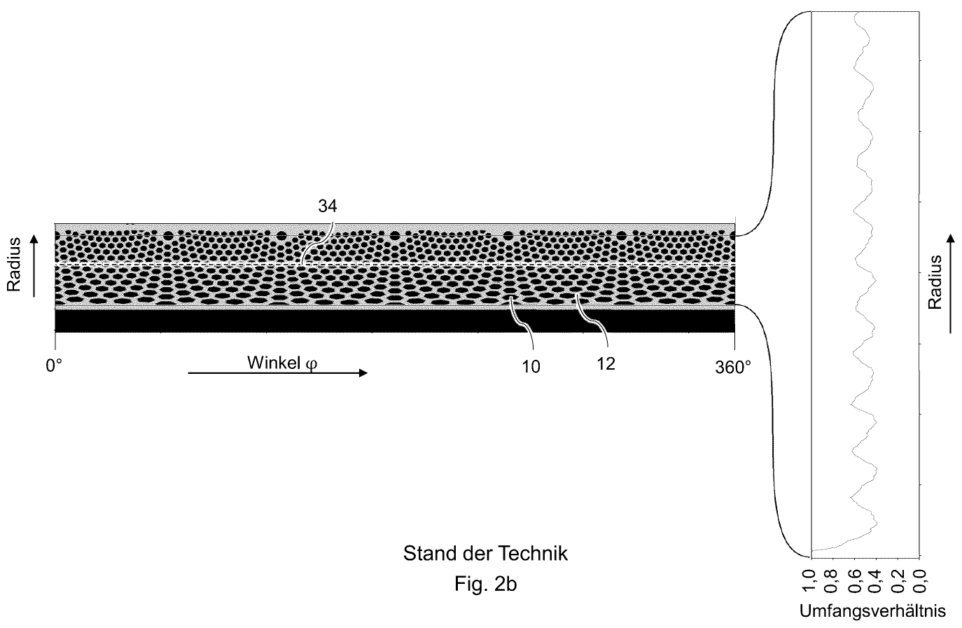

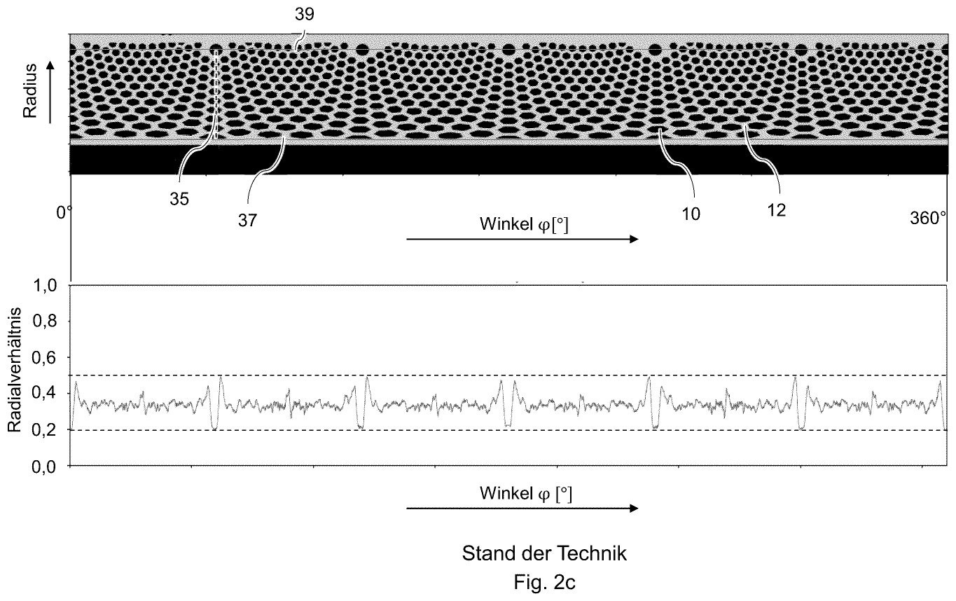

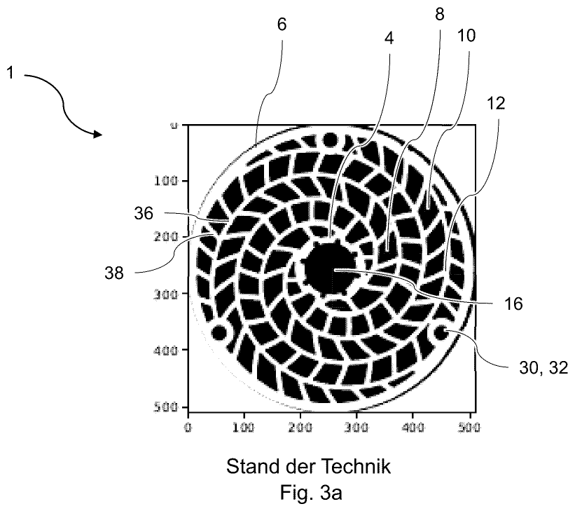

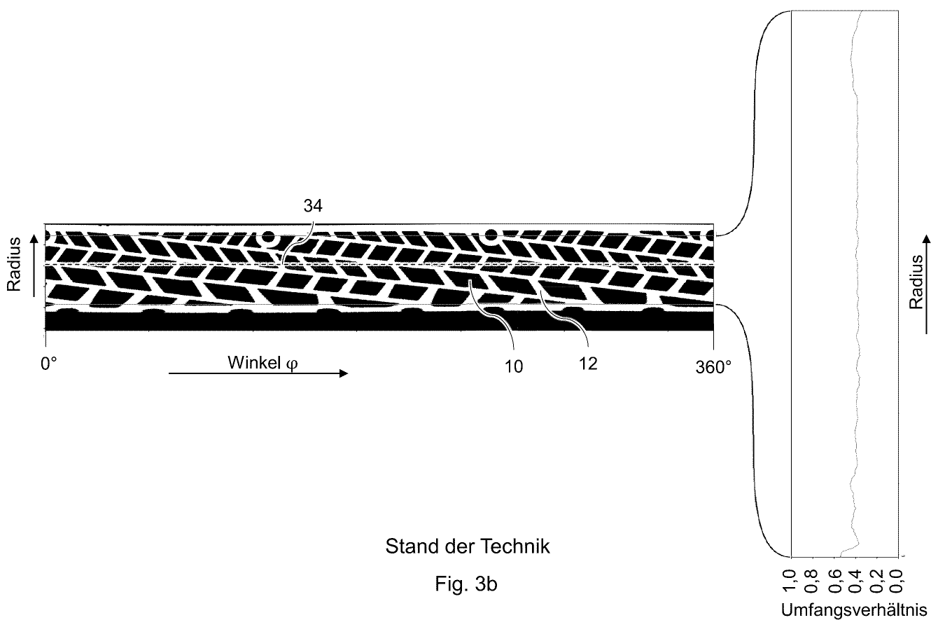

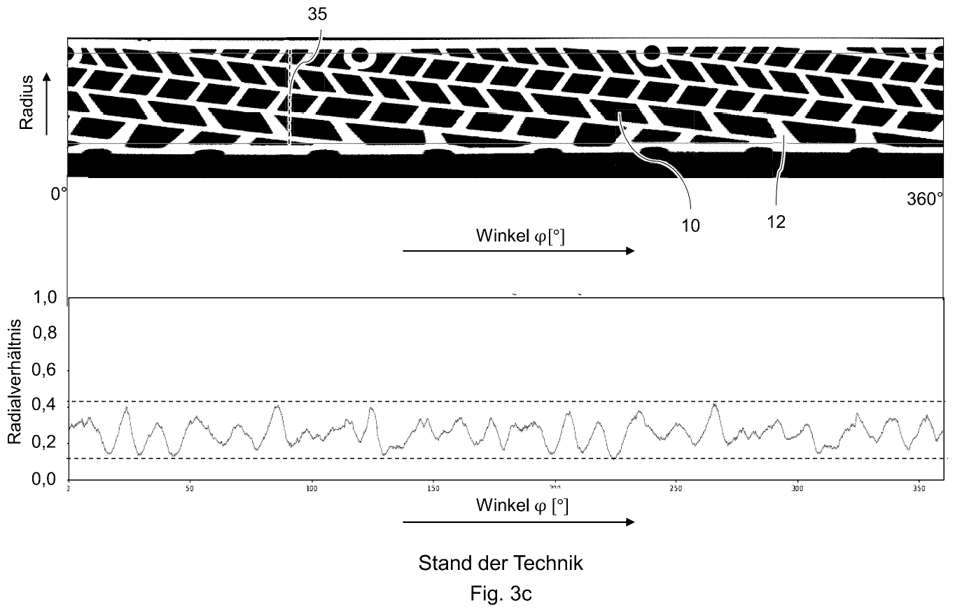

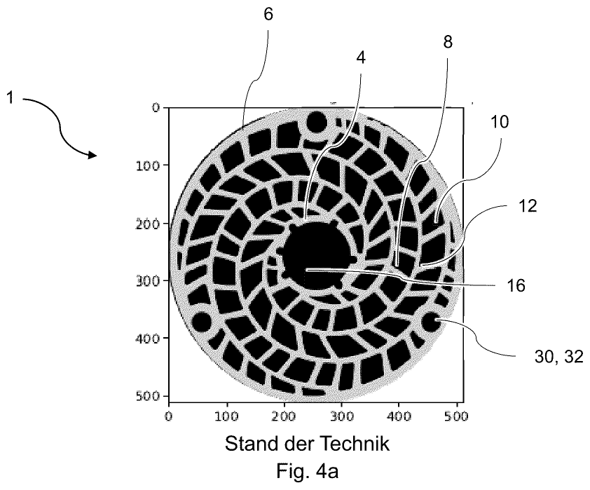

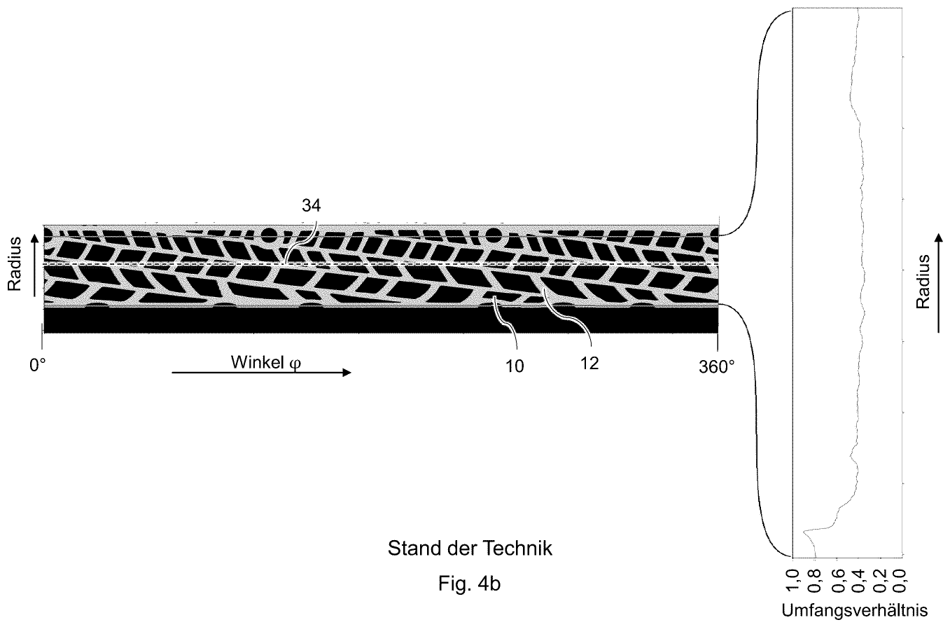

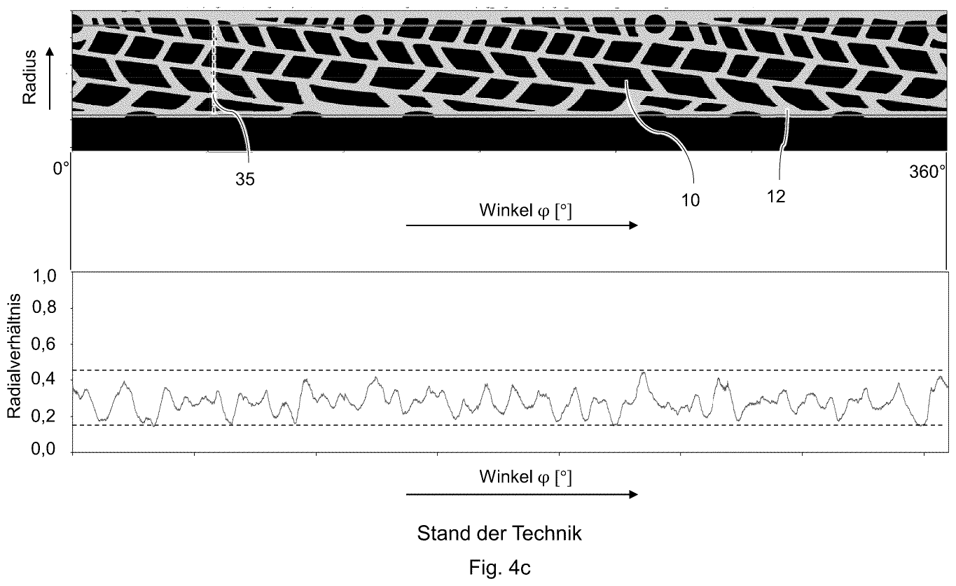

For cutting screens 1 known from the prior art, it has been found that the wear of the cutting blades 14 at different positions along the cutting edge 11 is of different strength. With cutting blades 14 worn to different strengths, the shearing forces between the cutting edges 11 and the cutting screen 1 are different along the length of the cutting edges 11. The use of the wet grinder 2 is then less efficient and maintenance has to be carried out to replace the cutting blades 14. Cutting screens 1 known from the prior art which, during operation, lead to nonuniform wear of the cutting blades 14 are shown in FIGS. 2a, 3a, and 4a. FIG. 2a, FIG. 3a, and FIG. 4a show the respectively depicted cutting screens 1 after a photographic recording. Blank sections 10 are illustrated here as dark and material sections 12 as bright.

The known cutting screens 1 in FIGS. 2a, 3a, and 4a each comprise an inner peripheral region 4, an outer peripheral region 6, and a working region 8 with blank sections 10 and material sections 12. An inner recess 16 is provided in the inner peripheral region 6, which is configured to receive a drive shaft 26 for rotationally driving at least one cutting blade 14 in operation. The cutting screens 1 furthermore comprise an outer peripheral region 6. The outer peripheral region 6 is provided with material on the circumference on the outside of a circle over the entire circumference. It furthermore comprises positioning elements 30 for positively positioning the cutting screen 1 within a wet grinder 2. These positioning elements 30 are configured here as bores 32.

The determination of the circumferential ratio and of the radial ratio is described below on the basis of FIGS. 2b to 2c: For the cutting screen 1 shown in FIG. 2a, FIGS. 2b, and 2c show a developed view. With computer-aided means, a Cartesian coordinate is assigned to each pixel of FIG. 2a with known angle position φ and known radius R, wherein the respective radius is plotted on the ordinate and the angle position φ multiplied by a constant K is plotted on the abscissa. Blank sections 10 close to the center of the circle cover a larger angle region in this view than empty sections 10 of similar size remote from the center of the circle, so that the representation of the empty sections 10 in the developed view of FIGS. 2b, 2c is distorted. FIG. 2b furthermore shows the profile of the circumferential ratio UV for a radius range of approximately 60 mm to approximately 210 mm. The circumferential ratio UV is the ratio of accumulated lengths of material sections 12 along a circumferential line to a circumference U associated with the circumferential line. As a result of the representation of the circular cutting screen 1 from FIG. 2a in a developed view in FIG. 2b, a circumferential ratio can be determined in that in FIG. 2b, in a first step, those lengths along the horizontal line 34 which run along brightly illustrated material sections 12 are summed along a horizontal line 34 from the left-hand end of the developed view to the right-hand end of the developed view. In a second step, a sum formed in this way is divided by the length of the horizontal line 34. This division is the circumferential ratio of the horizontal line 34, wherein a radius is assigned to the horizontal line corresponding to its position on the ordinate of the representation in FIG. 2b.

This procedure is repeated for a multiplicity of horizontal lines 34 in FIG. 2b, to which in each case different radii are assigned. In the example shown here, at least one pixel recording is recorded in each hundredth of the length of the outer radius Rout in the radial direction along the length of an outer radius Rout of the cutting screen, and a profile of circumferential ratios over the radius is determined in steps of at least one circumferential ratio per hundredth of the length of the outer radius Rout. Finer resolutions, that is to say a denser recording of pixels and/or the determination of more circumferential ratios than described here, are likewise preferred. In a further step, the value pairs of circumferential ratio and associated radius are plotted in a diagram or plotted with computer-aided means. In order to represent a curve, linear interpolation is carried out between the individual measured values. Such a diagram is shown on the right in FIG. 2b. The curved lines between the developed view and the profile of the circumferential ratio illustrate the radius region for which the evaluation was carried out here. For the circular cutting screen 1, a wave-like profile of the circumferential ratio over the radius is shown in this diagram. It can be seen that in this case there is no continuous, curvature-change-free circumferential function F, which maps circumferences U onto a reference circumferential ratio RUV in such a way that the circumferential ratio UV for each circumference U (or in the case of division of the respective circumference by 2×π: each radius) of a circle concentric to the cutting screen and lying within the working region does not deviate from the reference circumferential ratio RUV more than 0.05, preferably 0.03, preferably 0.01. For this reason, the cutting screen shown in FIG. 2a does not represent a cutting screen according to the invention, but is to be regarded as a comparative example.

The described analysis is preferably carried out by computer-aided means. A corresponding photographic light image can be divided into blank sections 10 and material sections 12, for example on the basis of a pixel analysis. The described development of the geometry, as shown in FIG. 2b and FIG. 2c, serves for illustration and is possible for determining a circumferential ratio or a profile of circumferential ratios along different circle radii or circle circumferences, but is not compulsory. With the aid of a suitable computer program, for example the center point of the cutting screen 1 can be determined, calculations of circumferential ratios for different radii can be carried out, the working region 8 can be delimited with respect to the inner peripheral region 4, and the outer peripheral region 6 and the profile of circumferential ratios along different radii or circumferences can be plotted in a suitable resolution. It can be seen in FIG. 2b that there is no corresponding continuous, curvature-change-free circumferential function F, for which the circumferential ratio UV for each circumference U of a circle concentric to the cutting screen 1 and lying within the working region 8 does not deviate more than 0.05, preferably 0.03, preferably 0.01. A corresponding test can equally well be carried out with the aid of a computer program, for example by examining the minima and maxima of the plotted circumferential ratio.

A graphic evaluation of the radial ratio RV for the cutting screen 1 from FIG. 2a is shown in FIG. 2c below the developed view. The evaluation is carried out analogously to the evaluation of the circumferential ratio, with the difference that no horizontal lines 34 are considered, but rather vertical lines 35. The evaluation is shown here in a region from a boundary 37 on the inside of a circle to a boundary 39 on the outside of a circle. Along a vertical line 35, the ratio of material sections 12 to the length of the vertical line 35 is the radial ratio RV. Such a radial ratio RV can be determined for angles of 0° to 360°. The maxima and minima of the radial ratio are marked in FIG. 2c. They are below 0.2 or above 0.5. A continuous, curvature-change-free function G, which maps circle angles onto a reference radial ratio RRV, wherein the radial ratio RV for each radial cutting line with a circle angle between 0° and 360° does not deviate from the reference radial ratio RRV more than 0.15, preferably 0.1, does not exist.

FIG. 3a shows a further known circular cutting screen 1 with first, spiral material struts 36, which run from an inner peripheral region 4 to an outer peripheral region 6 in the mathematically positive direction of rotation. The cutting screen 1 furthermore comprises second material struts 38, which abut the first material struts 36 without crossing them. FIGS. 3b and 3c show a developed view of the cutting screen 1 from FIG. 3a. Analogously to the analysis described for FIGS. 2a-2c, the circumferential ratio UV is determined for different radii of the cutting screen 1 from FIG. 3a and is shown in FIG. 3b. The profile of the circumferential ratio is less strongly wave-shaped than the circumferential ratio of the cutting screen 1 from FIG. 2a. Nevertheless, the profile of the circumferential ratio fluctuates along different radii (or circumferences) in such a way that there is no continuous, curvature-change-free circumferential function F, which maps circumferences U onto a reference circumferential ratio RUV in such a way that the circumferential ratio UV for each circumference U of a circle concentric to the cutting screen 1 and lying within the working region 8 does not deviate from the reference circumferential ratio RUV more than 0.05, preferably 0.03, preferably 0.01. For this reason, the cutting screen shown in FIG. 3a also does not represent a cutting screen according to the invention.

In FIG. 3c, the profile of the radial ratio RV over the angle φ of 0° to 360° for the cutting screen 1 from FIG. 3a is shown. The extremes are drawn in and are approximately 0.1 and more than 0.4. A continuous, curvature-change-free angle function G, which maps circle angles ¢ onto a reference radial ratio RRV in such a way that the radial ratio RV does not deviate from the reference radial ratio RRV more than 0.15, preferably 0.1, does not exist.

Analogously to the example shown in FIG. 3a, FIG. 4a shows a further embodiment of a known cutting screen. It differs, inter alia, in the central recess for receiving a shaft, in the configuration of the working region and in the positions of the positioning bores. On the basis of the graphic analysis of the circumferential ratios along different radii in FIG. 4b, which is based on the developed view from FIG. 4b, it is clearly recognizable by a visual analysis of the graph that the cutting screen 1 from FIG. 4a does not represent a cutting screen 1 according to the invention. The graph has discontinuities and pitch changes.

An analysis of the radial ratios RV of the cutting screen 1 from FIG. 4a along angle positions of 0° to 360° is shown in FIG. 4c. The extreme values deviate from one another by more than 0.3. There is no constant function and also no other continuous, curvature-change-free function G, which maps circle angles φ onto a reference radial ratio RRV, so that the radial ratio RV shown in FIG. 4c would not deviate from the reference radial ratio RRV by more than 0.15, preferably 0.1.

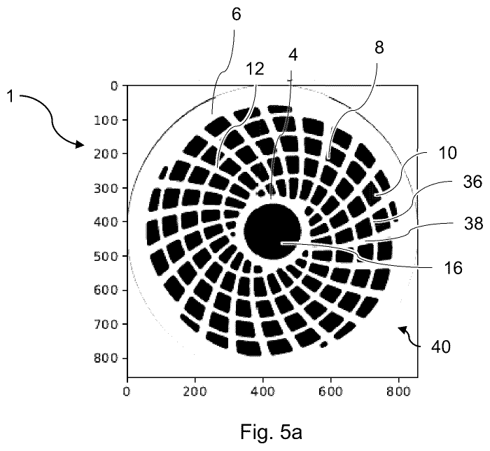

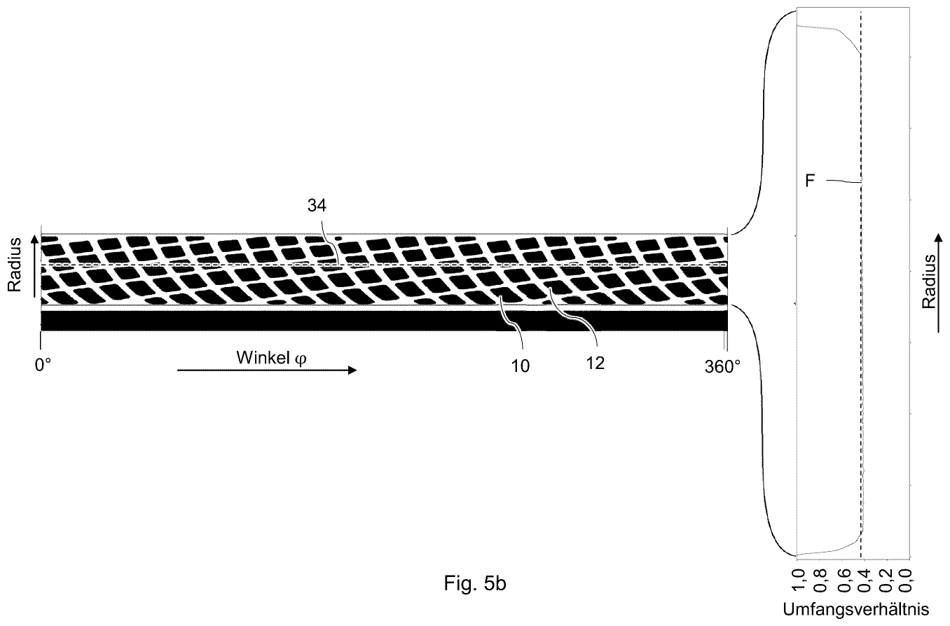

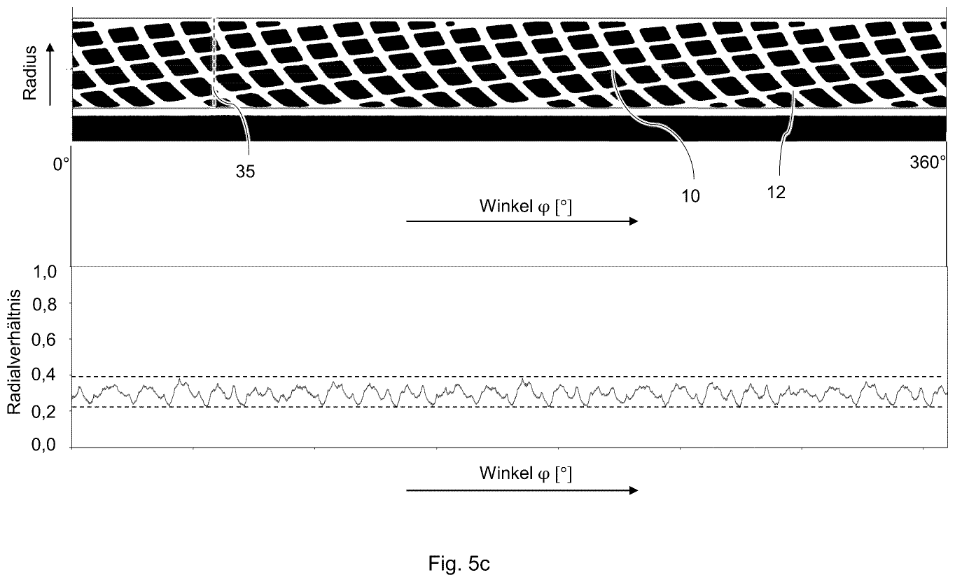

On the other hand, the cutting screen 1 with the geometry as shown in FIG. 5a is a cutting screen 1 according to the invention. It likewise comprises an inner peripheral region 4, an outer peripheral region 6, and a working region 8 of blank sections 10 and material sections 12, wherein the working region 8 is provided to be scraped over by a cutting edge 11 in operation. The material sections 12 are formed here on the one hand by first, spiral material struts 36, which run from the inner peripheral region 4 to the outer peripheral region 6 of the cutting screen 1 in the mathematically negative direction of rotation. In the exemplary embodiment shown here, five such first material struts 36 are present. The first material struts 36 run circularly involutely in the embodiment shown here. In order to obtain a constant cutting angle between the second material struts 38 along the radius, this is advantageous. On the other hand, material sections 12 are formed by second material struts 38 which are inverse to the first material struts 36. In the exemplary embodiment shown here, 23 such second material struts 38 are present. The second material struts 38 taper from radially outwards to radially inwards. In other embodiments, the material sections can consist of other elements or of material struts which have a different profile.

Blank sections 10 which are free of material are enclosed by the first material struts 36, the second material struts 38, the inner peripheral region 4, and the outer peripheral region 6. The various material sections 12 together form a lattice structure 40. In operation, only those shredded solids and/or fibers which are smaller than at least one of the blank sections 10 pass through the lattice structure 40. In addition, shredding to a statistical average degree of shredding also takes place of solids and/or fibers which are already smaller at the fluid inlet 20 in at least one dimension than blank sections of the lattice structure. When scraping over the cutting screen 1 with a straight cutting edge 11 of a cutting blade 14, cutting angles of approximately 20° are enclosed between the second material struts 38 and the cutting edge 11. The embodiment shown here comprises no centering bores 32 for positioning the cutting screen 1. Instead, the cutting screen 1 can be placed at its outer peripheral region 6 on a support surface within the machine housing 15 of the wet grinder 2. A second surface is lowered onto the other side of the cutting screen 1 and tightened by a screw connection, so that force-locked fixing of the cutting screen 1 takes place. However, bores 32 for positively positioning and fixing can equally well be provided. A recess 16 for receiving a drive shaft 18 is located on the inside of a circle, wherein the drive shaft 18 is in turn configured to move cutting blades 14 rotationally and relative to the cutting screen 1.

The cutting screen 1 has a thickness which is small in comparison to the diameter of the cutting screen 1. One side 42 (cf. FIG. 1) of the cutting screen 1 is in contact with the cutting edge 11 of the cutting blade 14 in operation and is configured to grind solids by shearing in interaction with the cutting edge 11. The other side 44 of the cutting screen 1 facing away from the cutting edge 11 is mirror-symmetrical to the first side 42. The second side 44 is less strongly exposed to a mechanical load by shearing forces. When the first side 42 of the cutting screen 1 wears, the second, non-worn side 44 can be used for shearing in interaction with the cutting edge 11 after the cutting screen 1 has been turned over.

Analogously to the procedure described in FIGS. 2a and 2b for determining the circumferential ratios UV or the profile of the circumferential ratio UV along different circumferences or radii, a developed view of the cutting screen 1 according to FIG. 5a and a plotted profile of the circumferential ratio UV along the radius are shown in FIG. 5b. The profile of the circumferential ratio UV over the radius is significantly more uniform for the cutting screen 1 according to FIG. 5a than for cutting screens 1 according to FIG. 2a, 3a, or 4a. The profile has only very small irregularities and no large discontinuities or pitch changes over a relatively long region.

There is a continuous, curvature-change-free circumferential function F, which maps circumferences U onto a reference circumferential ratio RUV in such a way that the circumferential ratio UV for each circumference of a circle concentric to the cutting screen 1 and lying within the working region 8 does not deviate from the reference circumferential ratio RUV=F(U) more than 0.05, preferably 0.03, preferably 0.01. Such a function F is shown by dashed lines in FIG. 5b. The function F is here a constant function. It would likewise be possible to use another function F′ which is, for example, a linear function with a small pitch and which likewise meets the criteria of continuity, freedom from curvature changes and the distance of the circumferential ratio UV from another reference circumferential ratio RUV′=F′ (U). It is essential that at least one such function F exists. In operation, a cutting edge 11 is stressed during one revolution along the length of the cutting edge 11 in a similar, approximately identical manner when using the cutting screen shown in FIG. 5a, because the duration of contacts with material sections 12 of the cutting screen 1 during one revolution is approximately the same at each position of the cutting edge 11. The wear of cutting edges 11 of the cutting blades 14 is thus advantageously approximately the same at the most diverse positions along the length of the cutting screen 1. The shearing effect is consequently also independent of the radial position along the cutting edge 11 in the advanced operating state and wear state of the cutting edges 11. A change of the cutting edge 11 is necessarily less frequently, i.e., maintenance intervals are lengthened and downtimes of the plant are shortened. The efficiency of the plant increases. Fewer consumable parts (in particular cutting blades 14) are required.

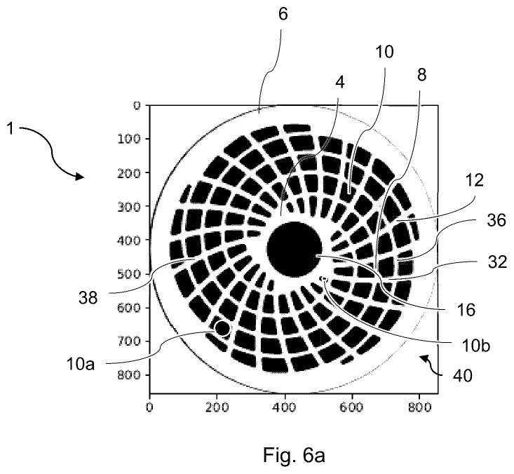

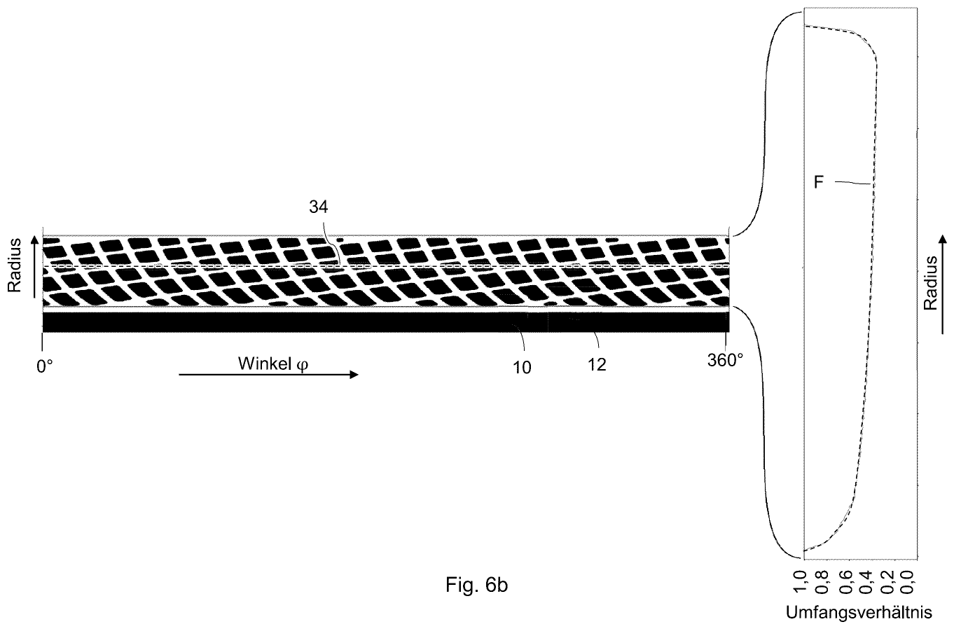

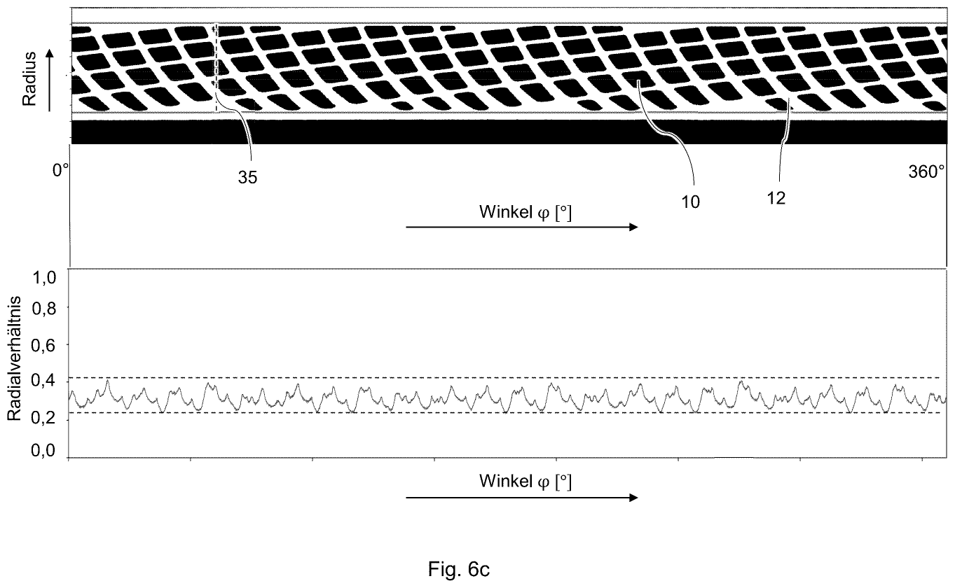

FIG. 6a shows a further embodiment of a cutting screen 1 according to the invention. Here, the second material struts 38 do not taper. They have a uniform strut width from radially inside to radially outside. Only in the region of the intersections with the first material struts 36 are they locally widened in such a way that the blank sections 10 enclosed by first material struts 36 and second material struts 38 have rounded corners. Such rounded corners are due to manufacturing constraints and the rounding radius can be, for example and preferably 0.1 mm, 0.5 mm, 1 mm, 1.5 mm, 3 mm, 4.5 mm or 6 mm. Both for the number of first material struts 36 and for the number of second material struts 38, in the example shown here, a strut number, namely five or twenty-three, is provided, which cannot be divided by the number of cutting blades when using, for example, two, three, or four cutting blades.

It should be understood that, in other embodiments, a different number of first material struts 36 and/or of second material struts 38 can be used. Preferably, for the number of first material struts 36 and/or second material struts 38 respectively, a number is used for which, when divided by the number of cutting blades 14 used, no integer quotient results.

From FIG. 5c it can furthermore be seen that the cutting screen 1 from FIG. 5a has a more uniform profile of the radial ratio RV along angles φ of 0° to 360° than known cutting screens. Extreme values of a plotted evaluation of the developed cutting screen 1 are more than 0.2 or less than 0.4. Consequently, a continuous, curvature-change-free function G exists for the cutting screen 1 from FIG. 5a, which maps reference radial ratios RRV onto angles φ, wherein the reference radial ratio does not deviate from the radial ratio more than 0.15, preferably 0.1. In the example shown here, the function G can be approximately a constant function, which assigns a reference radial ratio RRV of 0.3 to each angle φ. A corresponding tolerance band for a deviation of 0.15 ranges from 0.15 to 0.45. In the case of a permissible deviation of 0.1, a tolerance band of 0.2 to 0.4 is sufficient. The radial ratios shown in FIG. 5c are all within these two tolerance bands.

In comparison to the embodiment from FIG. 5a, the inner edge region 4 of the embodiment in FIG. 6a is larger. Radially inside, the blank sections 10 are smaller than radially outside. During the design of the cutting screen 1, the number of first material struts 36 and second material struts 38 is specified by specifying a predetermined pitch of the spirals or involutes and by specifying the widths of the first material struts 36 and second material struts 38.

As a result of such a design specification, resulting blank sections 10 which are too small for production with a production machine, e.g., a laser cutting machine or a milling tool, in particular blank sections 10 at the inner peripheral region 4, are preferably removed before a production order is placed, i.e., for a production order, such small blank sections 10 are not removed from a blank and instead these regions are configured as material sections 12. Blank sections 10 are preferably not taken into account for a production order, i.e., are not removed from the blank, if they are so small that blocking of the cutting screen 1 is to be expected in operation. Instead, a material section 12 is preferably provided in this region. The size of such a region, i.e., the size below which no blank section 10 but rather a material section 12 is provided, is dependent on the use case and in particular on the solids-loaded medium to be shredded. Blocking is advantageously prevented and it is prevented that a cutting blade 14 repeatedly brushes over a blockage and consequently wears more quickly.

It is thus ensured that at a blank section 10b the minimum ball passage diameter of all blank sections 10 is more than a predetermined value, i.e., that the cutting screen 1 is penetrable for balls (shown here in a circular shape) with a diameter of at least 30 mm. In other embodiments, however, other minimum ball passage diameters can also be selected, for example 25 mm, 20 mm, 15 mm, 10 mm or 5 mm. Analogously, another blank section 10a is that blank section which a (fictitious) ball with a maximum ball diameter can just no longer pass through. This value is 40 mm here, but in other embodiments can also be, for example, 35 mm, 30 mm, 25 mm, 20 mm, or 15 mm, wherein it is of course always greater than or equal to the minimum ball passage diameter. The selection of the size of the blank sections 10, of the minimum ball diameter and of the maximum ball diameter is dependent on the process, in particular on the medium to be shredded and the requirements for a degree of shredding of the medium.

Within the working region 8 there exists a curvature-free, continuous function F, which maps circumferences U onto a reference circumferential ratio in such a way that for all circumferential ratios within the working region the difference of the circumferential ratio from the reference circumferential ratio is less than 0.05, preferably 0.03, preferably 0.01. An example of such a function F is indicated by dashed lines in FIG. 6b. Analogously to the above-described functions of circumferential ratios UV with respect to different radii R, the representation in FIG. 6b is based on an evaluation of the developed view of the cutting screen 1 from FIG. 6a. The developed view is likewise shown in FIG. 6b.

The function F shown in FIG. 6b is convex. It should be understood that it is not necessary to define the function F mathematically on the basis of parameters and/or mathematical operators. A function is generally characterized in that it assigns precisely one function value (here: a theoretical reference circumferential ratio RUV) to each element of a set (here: the set of possible circumferences U of circles concentric to the cutting screen 1 within the working region 8). This applies to the function F indicated by dashed lines in FIG. 6b. This function F is continuous. It has no abrupt discontinuities.

It should be understood that the measured values of the circumferential ratio UV, or the interpolated profile of the measured values, can certainly have discontinuities. If, for the determination of the circumferential ratio UV, discrete measured values are recorded and linear interpolation is carried out between the measured values, a profile of the circumferential ratio UV measured in this way inevitably has discontinuities. However, such discontinuities are so small for a cutting screen 1 according to the invention, as depicted for instance in FIG. 6a, that the difference from a continuous, curvature-change-free function F is less than 0.05, preferably 0.03, preferably 0.01. In other words, around such a function F there exists a tolerance band with an extent of 0.1, preferably 0.06, preferably 0.02. All circumferential ratios UV of circles concentric to the cutting screen 1 within the working region 8 of the cutting screen 1 according to the invention lie within the tolerance band.

The contact times of the cutting screen 1 with the at least one cutting edge 11 along the cutting edge 11 are advantageously approximately the same for all points per revolution. For the profile depicted in FIG. 6b, the graph is degressive radially outwards within the working region 8, i.e. the contact times between cutting screen 1 and cutting edge 11 per revolution are longer radially outwards than radially inwards.

A depiction of the radial ratio RV for the cutting element 1 from FIG. 6a is shown in FIG. 6c. Analogously to the radial ratio described for the embodiment shown in FIGS. 5a and 5c, all values lie in a tolerance band around a function G, which maps angles φ onto a reference radial ratio continuously and curvature-change-free, wherein the tolerance band is narrower than 0.2.

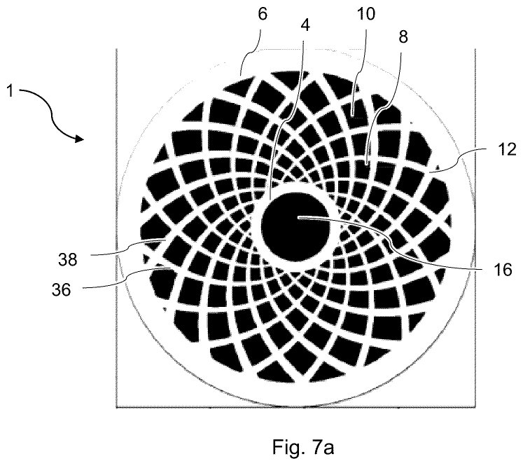

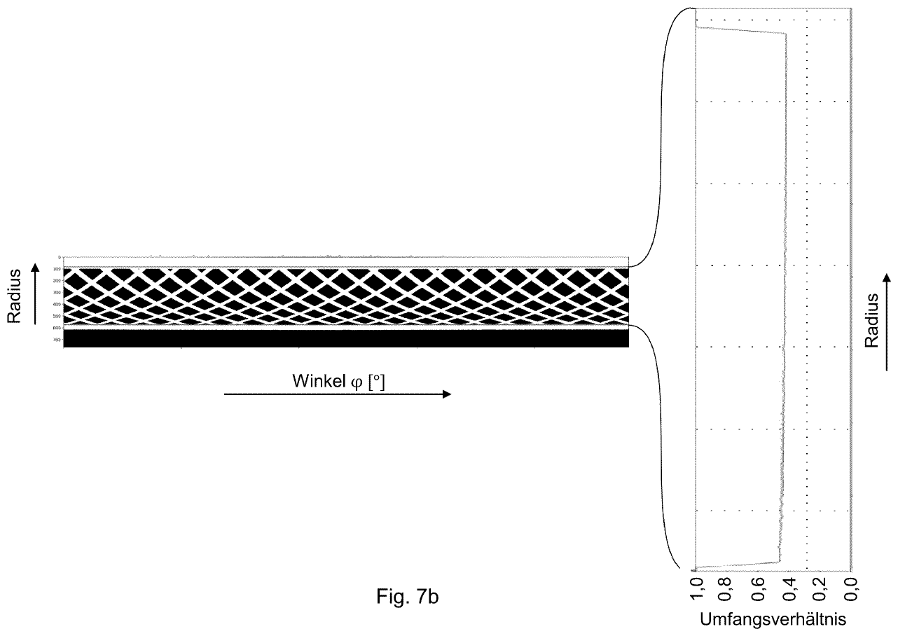

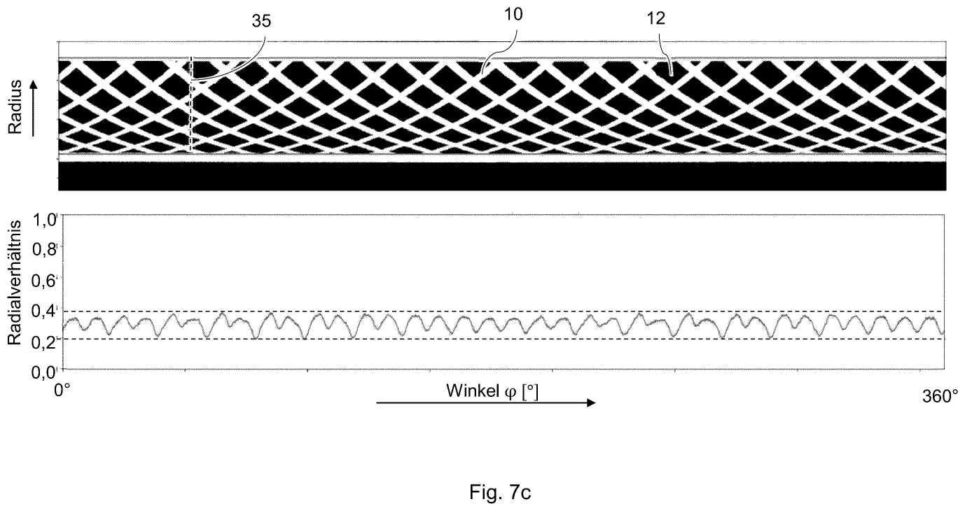

A further exemplary embodiment of a cutting screen according to the invention is shown in FIG. 7a. In FIG. 7b, a developed cutting screen corresponding to the exemplary embodiment according to FIG. 7a and an evaluation of the circumferential ratio UV are shown. It can be seen that hardly any fluctuations of the circumferential ratio occur and the latter is substantially constant along the radius R within the working region 8. In FIG. 7c, the profile of the radial ratio RV for the cutting screen 1 from FIG. 7a is shown. The radial ratio RV fluctuates within a tolerance band which is less than 0.2.

The exemplary embodiments shown here in FIGS. 5a, 6a, and 7a with spirally running first material struts 36 and opposite second material struts 38 are in each case one possible embodiment. Blank sections 10 are here approximately quadrangular, with rounded edges. Other embodiments differ, for example, in the number of first and/or second material struts 36, 38, by differently pronounced taperings of the first and/or second material struts 36, 38 and/or by different types and/or pitches of the spiral shapes. Other embodiments comprise round, triangular, polygonal, and/or drop-shaped blank sections 10 and/or have free shapes as blank sections 10. Combinations of differently shaped blank sections 10 are likewise possible.

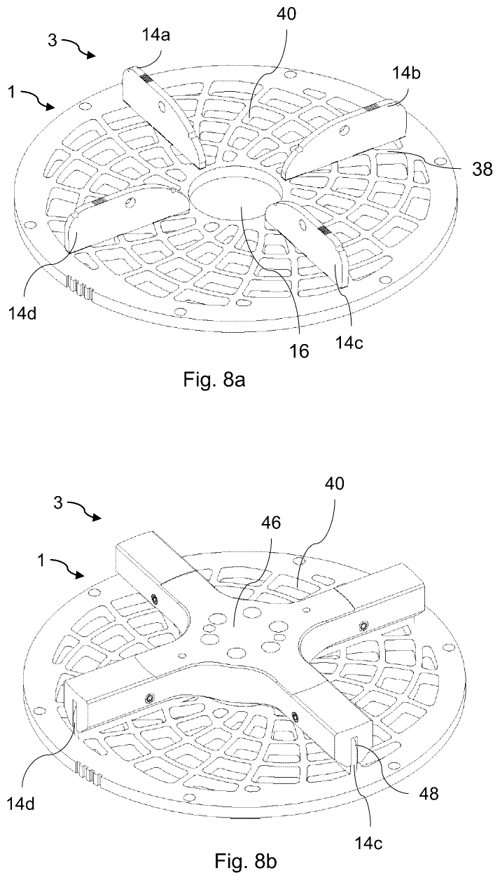

A system 3 of a cutting screen 1 with a lattice structure 40 and four cutting blades 14a, 14b, 14c, 14d is shown in FIG. 8a. The four cutting blades 14a, 14b, 14c, 14d are in each case arranged offset by 90° in the circumferential direction. Here, the cutting edges 11 of the cutting blades 14 are arranged skewed with respect to a central axis, that is to say with respect to an axis which runs through the center point of the circular central recess 16 and perpendicular to the cutting screen 1. The cutting blades 14a, 14b, 14c, 14d or the imaginary extension thereof do not intersect the central axis. The cutting blades 14a and 14b are not arranged in alignment but rather parallel to one another. The cutting blades include cutting angles of approximately 20° with the second material struts 38.

The four cutting blades 14a, 14b, 14c, 14d are partially enclosed and held by a rotor 46. In FIG. 8a, the rotor 46 is not shown for better illustration of the cutting blades 14a, 14b, 14c, 14d. The same system 3 with the rotor 46 shown is shown in FIG. 8b. In each case one cutting blade 14 is arranged in a respective groove 48 of the rotor 46. Rotation of the rotor 46 by means of the drive shaft 18 (cf. FIG. 9) causes the cutting blades 14a, 14b, 14c, 14d to scrape over the working region 8. In other embodiments, more or less than four cutting blades 14 can also be provided, for example three cutting blades 14 or six cutting blades 14, wherein the rotor 46 is correspondingly adapted to the number of cutting blades 14.

1-22. (canceled)

23. A cutting screen for use in wet shredders with an inner edge area and an outer edge area, wherein the cutting screen has a working area between the inner and outer edge areas consisting of empty sections and material sections, and wherein the working area is constructed to be swept over by at least one cutting edge during operation, wherein:
a circumferential ratio UV is the ratio of accumulated lengths of material sections A_{M} along a circumferential line to a circumference U associated with the circumferential line:
$$U V = \frac{{\sum }_{U} {A}_{M}}{U}$$
wherein, for the cutting screen, there exists at least one continuous circumferential function F without changes in curvature, which maps circumferences U to a reference circumferential ratio RUV:
$$F : U \to R U V$$
and wherein the circumference ratio UV for each circumference U of a circle concentric with the working area of the cutting screen and lying within the working area does not deviate from the reference circumference ratio RUV=F(U) by more than 0.05 of the reference circumference ratio (RUV) at the respective circumference.

24. The cutting screen according to claim 23, wherein a radial ratio RV is the ratio of all accumulated lengths of material sections A_{M} along a radial cutting line L to the length of the cutting line L, wherein the cutting line L encloses an angle φ∈[0°, 360°] with a radial horizontal cutting line;
wherein the cutting line extends across the working area without protruding into the inner edge area and/or into the outer edge area:
$$R V = \frac{{\sum }_{L} {A}_{M}}{L}$$
whereby for the cutting screen there exists at least one continuous, curvature-free angular function G that maps circular angles φ to a reference radial ratio RRV:
$$G : φ \to RRV$$
and wherein the radial ratio RV for each radial cutting line with a circular angle φ∈[0°, 360°] does not deviate from the reference radial ratio RRV=G(φ) by more than 0.15.

25. The cutting screen according to claim 23, wherein the function F is convex, linear, or constant.

26. The cutting screen according to claim 23, wherein the working area comprises an area of at least 30% of a front surface of the cutting screen and of at most 95 of the front surface of the cutting screen.

27. The cutting screen according to claim 23, the inner edge area having a central recess for receiving a rotating element, wherein the material sections are formed by
a first plurality of first material webs extending spirally from the inside to the outside; and
a second plurality of second material webs extending in a curved or spiral shape in the opposite direction to the first material webs from the inside to the outside,
wherein material-free empty sections are enclosed by the first material webs, the second material webs, the inner edge region and the outer edge region.

28. The cutting screen according to claim 27, wherein the first material webs extend in an involute shape or in a circular involute shape.

29. The cutting screen according to claim 27, wherein the second material webs cross the first material webs.

30. The cutting screen according to claim 27, wherein the second material webs do not taper radially outward or inward.

31. The cutting screen according to claim 27, wherein the second material webs taper radially outward.

32. The cutting screen according to claim 27, wherein the first material webs taper radially inward.

33. The cutting screen according to claim 27, wherein the second material webs extend continuously from the inner edge region to the outer edge region.

34. The cutting screen according to claim 27, wherein the cutting screen is adapted to enclose cutting angles in a range from 10° to 30 when interacting with the cutting edge.

35. The cutting screen according to claim 34, wherein each cutting angle is in a range of 10° to 30°.

36. The cutting screen according to claim 23, wherein the ball passage diameter of the empty sections is in a range from a lower limit of 5 mm to an upper limit of 40 mm.

37. The cutting screen according to claim 27, wherein the cutting screen has a higher hardness on the surface of the first and second material webs than inside the first and second material webs.

38. The cutting screen according to claim 23, wherein the outer edge region has holes for positioning and/or fixing the cutting screen in a wet grinder.

39. A system for shredding solids in mixed fluids, comprising a wet shredder having a cutting screen with an inner edge area and an outer edge area, wherein the cutting screen has a working area between the inner and outer edge areas consisting of empty sections and material sections, and wherein the working area is constructed to be swept over by at least one cutting blade during operation, wherein:
a circumferential ratio UV is the ratio of accumulated lengths of material sections A_{M} along a circumferential line to a circumference U associated with the circumferential line:
$$U V = \frac{{\sum }_{U} {A}_{M}}{U}$$
wherein, for the cutting screen, there exists at least one continuous circumferential function F without changes in curvature, which maps circumferences U to a reference circumferential ratio RUV:
$$F : U \to R U V$$
and wherein the circumference ratio UV for each circumference U of a circle concentric with the working area of the cutting screen and lying within the working area does not deviate from the reference circumference ratio RUV=F(U) by more than 0.05 of the reference circumference ratio (RUV) at the respective circumference.

40. The system according to claim 39, wherein the working area of the cutting screen is swept by the at least one cutting blade when the at least one cutting blade rotates and is at least partially in contact with the at least one cutting blade.

41. The system according to claim 39, wherein the axis of rotation of the at least one cutting blade is coaxial with a central axis of the working area.

42. The system according to claim 39, wherein the axis of rotation of the at least one cutting blade is coaxial with a central axis of the cutting screen.

43. The system according to claim 39, wherein the cutting screen further comprises a plurality of first material webs, and wherein the number of first material webs is not divisible by the number of cutting blades as an integer.

44. The system according to claim 43, wherein the cutting screen further comprises a plurality of second material webs, and wherein the number of second material webs is not divisible by an integer by the number of cutting blades.

45. A wet shredder comprising:
a housing;
a fluid inlet;
a fluid outlet;
a rotor driven by a drive; and
a cutting screen disposed between the fluid inlet and the fluid outlet, wherein the cutting screen further comprises an inner edge area and an outer edge area, a working area between the inner and outer edge areas consisting of empty sections and material sections, wherein the working area is constructed to be swept over by at least one cutting blade during operation, and wherein:
a circumferential ratio UV is the ratio of accumulated lengths of material sections A_{M} along a circumferential line to a circumference U associated with the circumferential line:
$$U V = \frac{{\sum }_{U} {A}_{M}}{U}$$
wherein, for the cutting screen, there exists at least one continuous circumferential function F without changes in curvature, which maps circumferences U to a reference circumferential ratio RUV:
$$F : U \to R U V$$
and wherein the circumference ratio UV for each circumference U of a circle concentric with the working area of the cutting screen and lying within the working area does not deviate from the reference circumference ratio RUV=F(U) by more than 0.05 of the reference circumference ratio (RUV) at the respective circumference.
